(19) United States
(12) Patent Application Publication
(10) Pub. No.: US 2021/0094672 A1
(43) Pub. Date: Apr. 1, 2021

(54) COLLAPSIBLE STABILIZER ASSEMBLY FOR AN AIRCRAFT

(71) Applicant: Shivanand SHARMA, Thatipur, Gwalior, Madhya Pradesh (IN)

(72) Inventors: Shivanand SHARMA, Thatipur, Gwalior, Madhya Pradesh (IN); Umanand SHARMA, Thatipur, Gwalior, Madhya Pradesh (IN)

(73) Assignee: Shivanand SHARMA, Thatipur, Gwalior, Madhya Pradesh (IN)

(21) Appl. No.: 17/053,782

(22) PCT Filed: Apr. 27, 2019
(86) PCT No.: PCT/IB2019/053467

§ 371 Date: Nov. 8, 2020

(30) Foreign Application Priority Data
May 8, 2018 (IN) 201821017378

(51) Int. Cl. B64C 5/10; B64C 31/032; B64C 5/06; B64C 9/00

(52) U.S. Cl. CPC B64C 5/10; B64C 9/00; B64C 5/06; B64C 31/032

(57) ABSTRACT

A collapsible stabilizer assembly to provide directional stability to a windmill or an aircraft is disclosed. The collapsible stabilizer assembly comprises at least one fin 200 having a leading member 202 and a trailing member 204 respectively coupled with a first tube 104 and a second tube 106 that are pivotally fixed to frame 102 of the aircraft. The leading member 202 includes a first hole 208 for engaging a fastening member 302 when the first hole 208 is in alignment with a second hole 108 that is configured in the first tube 104 so as to couple the leading member 202 and the first tube 104. Coupling of the leading member 202 and the trailing member 204 with the first tube 104 and the second tube 106 respectively allows quick installation as well as removal of the at least one fin 200 from the frame 102.

### TECHNICAL FIELD

The present disclosure relates to stabilizers for aircrafts. In particular, the present disclosure relates to a collapsible stabilizer assembly and technique for quick installation and removal of a stabilizer fin of an aircraft.

### BACKGROUND

Background description includes information that may be useful in understanding the present invention. It is not an admission that any of the information provided herein is prior art or relevant to the presently claimed invention, or that any publication specifically or implicitly referenced is prior art.

Microlight/Ultralight aircrafts and gliders are category of airplanes that are affordable and can be purchased without hassle. However, in order to operate these aircrafts, they need to be transported to an airfield and/or required to be parked at the airfield. Transportation and parking have their inherent difficulties that are neither easy nor cost effective. In addition, microlight airplanes need to be portable enough so that they are easily transportable to the airfield and involve less time for its components to get assembled and disassembled.

Flex wing aircrafts such as Hang Gliders, powered Hang Gliders, Paragliders, and powered Paragliders are cost effective to transport and operate. However, this category of airplanes has low aerodynamic performance, and therefore there is a need to create an aircraft with a collapsible stabilizer assembly that is quick to assemble for flight. In existing architectures, stabilizer assemblies of aircrafts does not easily collapse or fold, thereby increasing installation time and compromising portability of the aircrafts.

Therefore, in existing architectures, stabilizer assemblies are fixated with frame of the aircrafts to prevent undesired movement of fins and rudders, and therefore there is a need in the art for an improved collapsible stabilizer assembly and technique that provides for easy and time-saving installation as well as removal of fins of the aircrafts.

In some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

### OBJECTS OF THE INVENTION

A general object of the present disclosure is to provide a collapsible stabilizer assembly and technique for quick installation and removal of a stabilizer fin of an aircraft.

An object of the present disclosure is to provide a portable collapsible stabilizer assembly of an aircraft.

Another object of the present disclosure is to provide a collapsible stabilizer assembly that is easily collapsible.

Another object of the present disclosure is to provide a collapsible stabilizer assembly that enables quick assembly of a stabilizer fin of the aircraft.

Another object of the present disclosure is to provide a collapsible stabilizer assembly that can be incorporated as an aircraft wing assembly or tail assembly having any of V-tail, cruciform tail, wingtip, winglet and the like configurations.

Yet another object of the present disclosure is to provide a collapsible stabilizer assembly that improves portability of the aircraft.

Still another object of the present disclosure is to provide a collapsible stabilizer assembly that may be retrofitted to existing microlight as well as flex wing aircrafts without any major design alterations.

### SUMMARY

The present disclosure relates to stabilizers of aircrafts. In particular, the present disclosure relates to a collapsible stabilizer assembly and technique for quick installation and removal of a stabilizer fin of a windmill apparatus or an aircraft such as a microlight/ultralight aircraft, a flex wing aircraft, an unmanned aerial vehicle (UAV) and the likes.

An aspect of the present disclosure relates to a collapsible stabilizer assembly that provides directional stability to an aircraft. The collapsible stabilizer assembly includes at least one fin having a leading member and a trailing member. The leading member and the trailing member are respectively coupled with a first tube and a second tube that are pivotally fixed to frame of the aircraft. In an embodiment, diameter of each of the first tube and second tube is less than diameter of each of the leading member and trailing member such that the first tube and the second tube are capable of being inserted into the leading member and the trailing member respectively.

In an aspect, coupling of the leading member and the trailing member with the first tube and the second tube respectively allows quick installation of the at least one fin to the frame.

In an aspect, the leading member includes a first hole for engaging a fastening member when the first hole is in alignment with a second hole that is configured in the first tube so as to couple the leading member and the first tube. In an embodiment, the fastening member is any or a combination of a stud, a bolt, a pin and a quick release pin.

In an embodiment, top end of the leading member is connected to top end of the trailing member. In an embodiment, the frame includes a link traversing through lateral direction of the aircraft and located at an offset distance from the trailing member. In an embodiment, the link is configured with at least two cables that are connected between ends of the link and top end of the trailing member. This offset assists in coupling of a cable pivot/stud with top end of the trailing member.

In an embodiment, the collapsible stabilizer assembly further includes a rudder pivotally attached to the at least one fin for controlling yaw of the aircraft.

In an embodiment, the collapsible stabilizer assembly further includes a fabric wrapped around the leading edge and the tailing edge such that the fabric covers the at least one fin. The fabric is tensioned during assembly of the at least one fin with the frame and once the at least one fin is completely assembled with the frame, an adequate fabric tension is accomplished.

In an embodiment, tension in the fabric gradually increases with assembly of the at least one fin with the frame.

In an embodiment, the at least two cables are connected between ends of the link and top end of the trailing member prior to coupling of the leading member and the trailing member with the first tube and the second tube respectively, to assist tensioning of the fabric.

In an embodiment, in case the fabric covering the at least one fin is in pre-tensioned condition, the first tube is removed and the leading edge is fastened with a pivotal member the frame using any or a combination of a stud, a bolt, a pin and a quick release pin. In an embodiment, when the fabric covering the at least one fin is in the pre-tensioned condition the at least one fin construe a single frame structure having the leading member and the trailing member emanating outwards at a bottom end of the at least one fin.

Another aspect of the present disclosure relates to an aircraft that includes a frame having at least a first tube and a second tube that are pivotally fixed to the frame, and a collapsible stabilizer assembly to provide directional stability to the aircraft. The collapsible stabilizer assembly includes at least one fin having a leading member and a trailing member operatively coupled with the first tube and the second tube respectively. The leading member includes a first hole for engaging a fastening member when the first hole is in alignment with a second hole that is configured in the first tube so as to couple the leading member and the first tube. In an aspect, coupling of the leading member and the trailing member with the first tube and the second tube respectively allows quick installation of the at least one fin to the frame.

In an embodiment, the fastening member is any or a combination of a stud, a bolt and a pin.

In an embodiment, diameter of each of the first tube and second tube is less than diameter of each of the leading member and trailing member such that the first tube and the second tube are capable of being inserted into the leading member and the trailing member respectively.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

The diagrams are for illustration only, which thus is not a limitation of the present disclosure, and wherein:

FIGS. 1A and 1B illustrate exemplary representations of first tube and second tube pivotally fixed to frame of an aircraft in accordance to an embodiment of the present disclosure.

FIG. 2 illustrates an exemplary representation of a fin of proposed collapsible stabilizer assembly in accordance to an embodiment of the present disclosure.

FIG. 3 illustrates an exemplary representation of assembly of the fin with the frame of the aircraft in accordance to an embodiment of the present disclosure.

FIGS. 4A and 4B illustrate exemplary side view and rear view respectively of the collapsible stabilizer assembly installed on the frame of the aircraft in accordance to an embodiment of the present disclosure.

FIG. 5 illustrates an exemplary representation of a rudder coupled with the fin of the collapsible stabilizer assembly in accordance to an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Various terms as used herein are explained below. To the extent a term used in a claim is not defined below, it should be given the broadest definition persons in the pertinent art have given that term as reflected in printed publications and issued patents at the time of filing.

The present disclosure relates to stabilizers of aircrafts. In particular, the present disclosure relates to a collapsible stabilizer assembly and technique for quick installation and removal of a stabilizer fin of a windmill apparatus or an aircraft such as a microlight/ultralight aircraft, a flex wing aircraft, an unmanned aerial vehicle (UAV) and the likes.

An aspect of the present disclosure relates to a collapsible stabilizer assembly that provides directional stability to the aircraft. The collapsible stabilizer assembly includes at least one fin having a leading member and a trailing member. The leading edge and the trailing edge are respectively coupled with a first tube and a second tube that are pivotally fixed to frame of the aircraft. In an embodiment, diameter of each of the first tube and second tube is less than diameter of each of the leading edge and trailing edge such that the first tube and the second tube are capable of being inserted into the leading edge and the trailing edge respectively.

In an aspect, coupling of the leading edge and the trailing edge with the first tube and the second tube respectively allows quick installation and removal of the at least one fin to the frame.

In an aspect, the leading edge includes a first hole for engaging a fastening member when the first hole is in alignment with a second hole that is configured in the first tube so as to couple the leading edge and the first tube. In an embodiment, the fastening member is any or a combination of a stud, a bolt and a pin.

In an embodiment, top end of the leading edge is connected to top end of the trailing edge. In an embodiment, the frame includes a link traversing through lateral direction of the aircraft and located at an offset distance from the trailing edge towards rear end of the aircraft. In an embodiment, the link is configured with at least two cables that are connected between ends of the link and top end of the trailing member. This offset assists in coupling of a cable pivot/stud with top end of the trailing member.

In an embodiment, the collapsible stabilizer assembly further includes a rudder pivotally attached to the at least one fin for controlling yaw of the aircraft.

In an embodiment, the collapsible stabilizer assembly further includes a fabric wrapped around the leading edge and the tailing edge such that the fabric covers the at least one fin. The fabric is tensioned during assembly of the at least one fin with the frame and once the at least one fin is completely assembled with the frame, an adequate fabric tension is accomplished.

In an embodiment, tension in the fabric gradually increases with assembly of the at least one fin with the frame.

In an embodiment, the at least two cables are connected between ends of the link and top end of the trailing member prior to coupling of the leading member and the trailing member with the first tube and the second tube respectively, to assist tensioning of the fabric.

In an embodiment, in case the fabric covering the at least one fin is in pre-tensioned condition, the first tube is removed and the leading edge is fastened with a pivotal member the frame using any or a combination of a stud, a bolt, a pin and a quick release pin. In an embodiment, when the fabric covering the at least one fin is in the pre-tensioned condition the at least one fin construe a single frame structure having the leading member and the trailing member emanating outwards at a bottom end of the at least one fin.

Another aspect of the present disclosure relates to an aircraft that includes a frame having at least a first tube and a second tube that are pivotally fixed to the frame, and a collapsible stabilizer assembly to provide directional stability to the aircraft. The collapsible stabilizer assembly includes at least one fin having a leading member and a trailing member operatively coupled with the first tube and the second tube respectively. The leading member includes a first hole for engaging a fastening member when the first hole is in alignment with a second hole that is configured in the first tube so as to couple the leading member and the first tube. In an aspect, coupling of the leading member and the trailing member with the first tube and the second tube respectively allows quick installation of the at least one fin to the frame.

In an embodiment, the fastening member is any or a combination of a stud, a bolt, a pin, a quick release pin (QRP) and the likes.

In an embodiment, diameter of each of the first tube and second tube is less than diameter of each of the leading member and trailing member such that the first tube and the second tube are capable of being inserted into the leading member and the trailing member respectively.

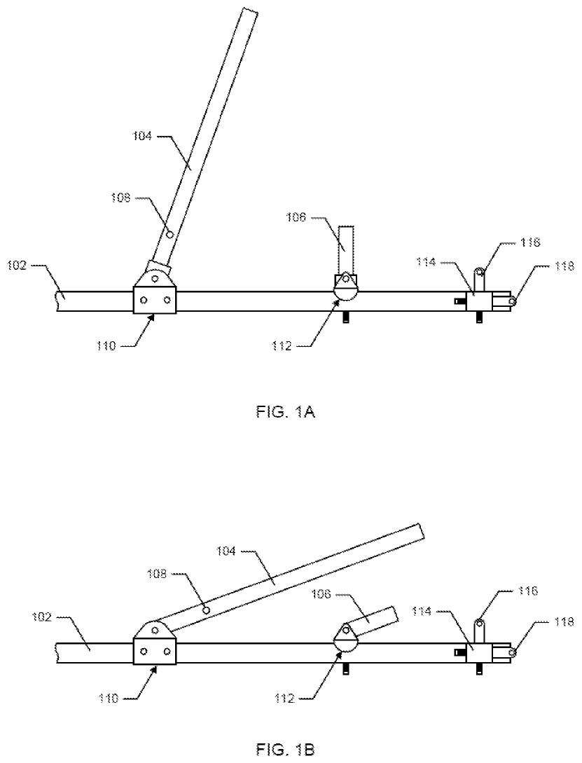

FIGS. 1A and 1B illustrate exemplary representations of first tube and second tube pivotally fixed to frame of an aircraft in accordance to an embodiment of the present disclosure. In an aspect, frame 102 of the aircraft can include a first tube 104 and a second tube 106 that are pivotally fixed to the frame 102 with the help of pivoting members 110 and 112 respectively.

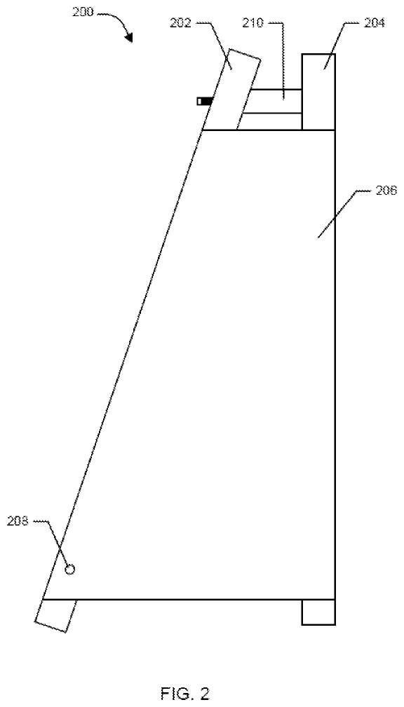

In an embodiment, the pivoting members 110 and 112 can be a set of plates/clamps that are bolted together to impart pivot/hinged motion of the first tube 104 and the second tube 106 respectively about their pivoted ends that are coupled/fastened to the pivoting members 110 and 112 respectively with the help of bolts. The pivoting members 110 and 112 can be bolted to the frame to provide a firm support to the first tube 104 and the second tube 106. In an embodiment, the pivoting members 110 and 112 can include bushes to damp vibrations and/or unbalanced loads during coupling of the stabilizer fin (as shown in FIG. 2) to the frame 102 of the aircraft.

In an embodiment, length of the first tube 104 and the second tube 106 may be equal or unequal depending on requirement. The first tube 104 can include a hole 108 (also referred to as “second hole 108” hereinafter) at a pre-determined distance above its pivoted end.

In an embodiment, the first tube 104 and the second tube 106 can pivotally move about their respective pivoted ends irrespective of each other such that each of the first tube 104 and the second tube 106 can be aligned at different angles with a horizontal plane.

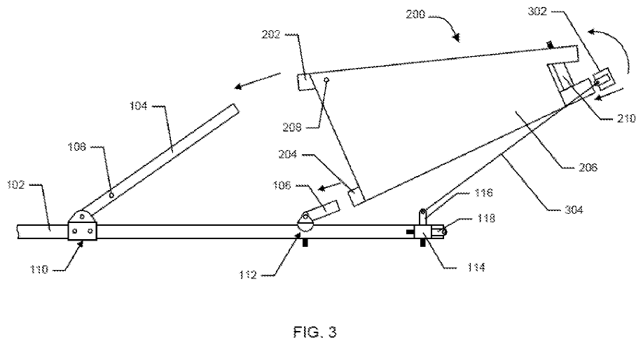

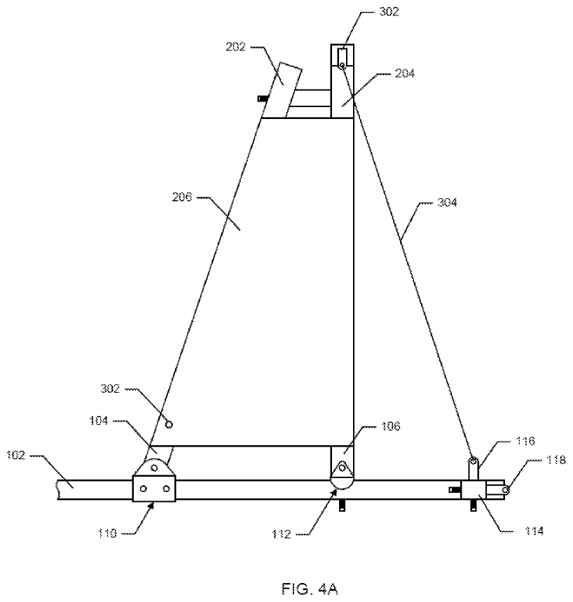

In an embodiment, a rear portion of the frame 102 can include a link 114 that is used to couple an elevator assembly to the frame 102 of the aircraft in order to provide for control of pitch of the aircraft. The elevator assembly can traverse through lateral direction of the frame 102 such that ends of the link 114 are available on either lateral side of the frame 102. The elevator assembly can include a plurality of elevators that act as flight control surfaces and control angle of attack and lift of wings of the aircraft. The link 114 can include at least two fasteners 116, such as eye bolts, hooks and tangs that are used to connect top end of fin of the collapsible stabilizer assembly to the link 114 with the help of cables/wires (as shown in FIG. 3). The link 114 may include fasteners 118, such as eye bolts, hinge and brackets to assist coupling of the elevator assembly with the link 114.

In an embodiment, the proposed fin of the collapsible stabilizer assembly is coupled/assembled with the frame 102 by inserting the first tube 104 and the second tube 106 into the leading member (interchangeably referred to as “leading edge” hereinafter) and trailing member of the fin and rotating the fin such that the trailing member (interchangeably referred to as “trailing edge” hereinafter) of the fin is aligned in parallel with a vertical plane. Thereafter, the leading member can be fastened/bolted to the first tube 104 to enable a firm coupling of the fin to the frame 102 of the aircraft.

FIG. 2 illustrates an exemplary representation of fin of the proposed collapsible stabilizer assembly in accordance to an embodiment of the present disclosure. In an aspect, the fin 200 can include a leading edge 202 and a trailing edge 204 pivotally connected at their top ends through a connector assembly 210. Top end of the leading edge 202 can be fastened to top end of the trailing edge 204 with the help of the connector assembly 210. The connector assembly 210 can include a bush inserted between the top ends of the leading edge 202 and the trailing edge 204 with a bolt fastening the top ends of the leading edge 202 and the trailing edge 204.

In an embodiment, the trailing edge 204 of the fin 200 may be pivotally attached with a rudder (not shown here) with the help of pivot mechanisms for controlling yaw of the aircraft. The rudder can pivotally move about its pivoted side in order to control directional orientation of the aircraft.

In an embodiment, a fabric 206 can be wrapped around the leading edge 202 and the trailing edge 204 such that the fabric 206 can cover the fin 200. In an embodiment, the fabric 206 can be a material that is used to cover open structures/components of an aircraft. The fabric 206 can be made up of any of a Dacron material, a Poly-fiber material, a reinforced plastic, a metal, a metal-polymer composite and the likes. The fabric 206 improves aerodynamic property of the aircraft by aiding directional stabilization of the aircraft.

In an embodiment, the leading edge 202 can include a hole 208 (also referred to as “first slot 208” hereinafter) at a pre-determined distance spaced from its lower end. Diameter of the leading edge 202 and the trailing edge 204 of the fin 200 can be greater than diameter of the first tube 104 and the second tube 106 of the frame 102 respectively to allow insertion of the first tube 104 and the second tube 106 into the leading edge 202 and the trailing edge 204 respectively.

In an embodiment, the first tube 104 and the second tube 106 can be inserted into the leading edge 202 and the trailing edge 204 respectively such that when the first slot 208 and the second slot 108 align, a fastening member 302 can be passed through the first slot 208 and the second slot 108 to enable fastening/coupling of the leading edge 202 of the fin to the first tube 104 of the frame 102 of the aircraft.

In an embodiment, the fabric 206 can be initially in a loose/slack condition. When the first tube 104 and the second tube 106 is inserted into the leading edge 202 and the trailing edge 204 respectively and the fin 200 is rotated about pivoted ends of the first tube 104 and the second tube 106, tension in the fabric 206 gradually increases such that when the trailing edge is substantially parallel to a vertical plane, tension in the fabric 206 can assist directional stability of the aircraft. In an embodiment, bottom end of the fabric 206 can be configured with an attachment, such as a velcro fastener that acts as a closure for bottom end of the fabric 206.

FIG. 3 illustrates an exemplary representation of assembly of the fin with the frame of the aircraft in accordance to an embodiment of the present disclosure. In an aspect, the fin 200 can be assembled and disassembled from the frame 102 in such a way that allows quick installation and removal of the fin 200 from the frame 102.

In an embodiment, the first tube 104 and the second tube 106 can be rotated about their respective pivoted ends such that they are in a suitable position to be inserted into the leading tube 202 and the trailing tube 204 of the fin 200. Then, the first tube 104 is inserted into the leading edge 202 of the fin 200, and subsequently, the second tube 106 is inserted into the trailing edge 204. Thereafter, the leading edge 202 and the trailing edge 204 are slided towards pivoted ends of the first tube 104 and the second tube 106 respectively. When first hole 208 of the leading edge 202 aligns with second hole 108 of the first tube 104, a fastening member 302, such as, but not limited to, a bolt, a pin or a stud is passed through the holes 108/208 and fastened from its other end to enable coupling of the leading edge 202 and the first tube 104.

In an embodiment, fabric 206 of the fin 200 can be initially in a loose condition. In an embodiment, top end of the leading edge 202 can be connected to top end of the trailing edge 204 through the connector assembly 210. In an embodiment, the frame 102 can include a link 114 that traverses through lateral direction of the aircraft and is located at an offset distance from the trailing edge 204 in a longitudinal direction towards rear end of frame 102 of the aircraft. The offset assists connection of at least two cables/wires 304 attached to ends of the link 114 with top end of the trailing edge 204.

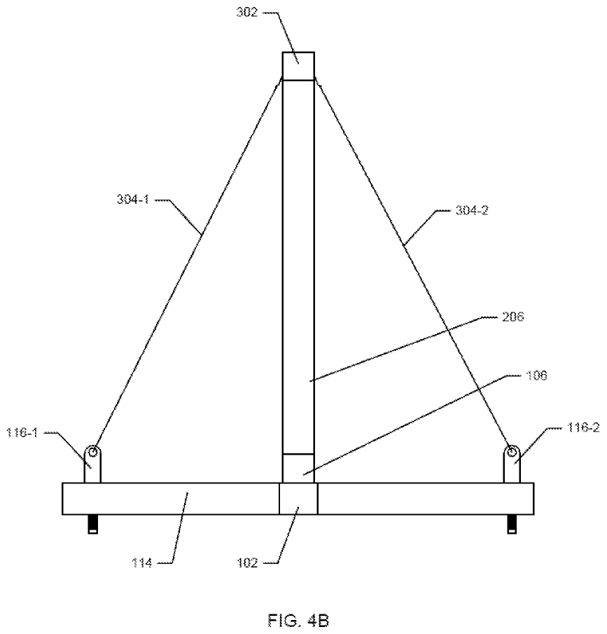

In an embodiment, cables 304 can be connected to lateral sides of top end of the trailing edge 204 with the help of a cable connector (also referred to as cable clamp hereinafter) 302 having two cable attachments to provide harnessing to the cables 304. Further, cables 304-1 and 304-2 can be respectively connected to fasteners 116-1 and 116-2, such as eye bolts, hooks and tangs of the link 114 (shown in FIG. 4B).

In an embodiment, each end of the link 114 is configured with the fasteners 116 to allow at least two cables to be connected between ends of the link 114 and top end of the trailing edge 204.

In an embodiment, the cable clamp 302 is coupled with top end of the trailing edge 204 prior to insertion of the first tube 104 and the second tube 106 into the leading edge 202 and the trailing edge 204 of the fin 200 to allow connection between the top end of the trailing edge 204 and the link 114 that is located at an offset distance from the trailing edge 204. This offset of the link 114 from the trailing edge 204 aids in alignment of the cables 304 when the fin 200 is assembled with the frame 102.

In an embodiment, the cables 304 are connected between ends of the link 114 and top end of the trailing member 204 prior to coupling of the leading member 202 and the trailing member 204 with the first tube 104 and the second tube 106 respectively, to assist tensioning of the fabric 206.

In an embodiment, in case the fabric 206 covering the at least one fin 200 is in pre-tensioned condition, the first tube 104 is removed from the frame 102 and the leading member 202 is fastened with a pivotal member the frame 102 using any or a combination of a stud, a bolt, a pin and a quick release pin. In an embodiment, when the fabric 206 covering the fin 200 is in the pre-tensioned condition the fin 200 construe a single frame structure having the leading edge 202 and the trailing edge 204 emanating outwards at a bottom end of the fin 200.

In an embodiment, after the first tube 104 is inserted into the leading edge 202 and the second tube 106 is inserted into the trailing edge 204, the fin 200 is rotated about pivoted ends of the first tube 104 and the second tube 106 till the trailing edge 204 is oriented in a vertical configuration.

In an embodiment, when the first tube 104 and the second tube 106 are inserted into the leading edge 202 and the trailing edge 204 respectively and the fin 200 is rotated about pivoted ends of the first tube 104 and the second tube 106, tension in the fabric 206 gradually increases such that when the trailing edge is substantially parallel to a vertical plane, tension in the fabric 206 can assist directional stability of the aircraft. Thus, assembly of the proposed fin 200 with the frame also acts as a fabric tensioning mechanism. In an embodiment, bottom end of the fabric 206 can be configured with an attachment, such as a velcro fastener that acts as a closure for bottom end of the fabric 206.

In an embodiment, when the first hole 208 of the leading edge 202 of the fin 200 coincides with the second hole 108 of the first tube 104 of the aircraft frame 102, a fastening member 302 can be passed through the holes 108/208 and can be tightened from the other end to enable coupling of the leading edge 202 and the first tube 104. In an embodiment, the fastening member can be any or a combination of a stud, a bolt, a pin, a quick release pin (QRP) and the like fasteners.

In an aspect, coupling of the leading edge 202 and the trailing edge 204 of the fin 200 with the first tube 104 and the second tube 106 of the frame 102 respectively provided for quick installation as well as removal of the fin 200. In an embodiment, fin 200 can be disassembled from the frame 102 by simply removing the fastening member 302 and rotating the fin 200 about the pivoted ends of the first tube 104 and the second tube 106 and sliding the fin 200 away from the frame 102. The fabric 206 loses tension due to disassembly of the fin 200 from the frame 102 and becomes easy to store. Thus, the proposed assembly technique complements portability of the aircraft by providing a collapsible stabilizer assembly that can be easily assembled and disassembled in lesser time interval than conventional stabilizer assemblies.

It would be appreciated that although the present disclosure is explained in terms of a collapsible stabilizer assembly configured at a rear portion of frame of an aircraft, scope of the present disclosure is not limited to the same in any way whatsoever, and implementation of the proposed collapsible stabilizer assembly to other aircraft wing/tail configurations such as conventional tail configuration, V-tail configuration, Cruciform tail configuration, wingtip configuration, winglet configuration and the likes, windmills and watercrafts is well within the scope of the present disclosure.

FIGS. 4A and 4B illustrate exemplary side view and rear view respectively of the collapsible stabilizer assembly installed on the frame of the aircraft in accordance to an embodiment of the present disclosure. In an embodiment, a plurality of cables/wires 304-1 and 304-2 can be provided to the collapsible stabilizer assembly that connect ends of the link 114 to top end of the trailing edge 204 to support movement and orientation of the elevator assembly coupled with the link 114.

In an embodiment, cables 304 can be connected to either lateral side of the top end of the trailing edge 204 with the help of a cable connector (also referred to as cable stud or cable clamp) 302 having two cable attachments to provide harnessing to the cables 304. Further, cables 304-1 and 304-2 can be respectively connected to fasteners 116-1 and 116-2, such as eye bolts, hooks and tangs of the link 114, as shown in FIG. 4B.

In an embodiment, the proposed stabilizer assembly incorporates less number of components that a conventional fin and rudder assembly. For example, the proposed stabilizer assembly eliminates requirement of a bottom link to be connected between the leading edge and the trailing edge, thereby providing a weight advantage to the proposed stabilizer assembly. This reduces weight of the proposed stabilizer assembly and further improves its portability.

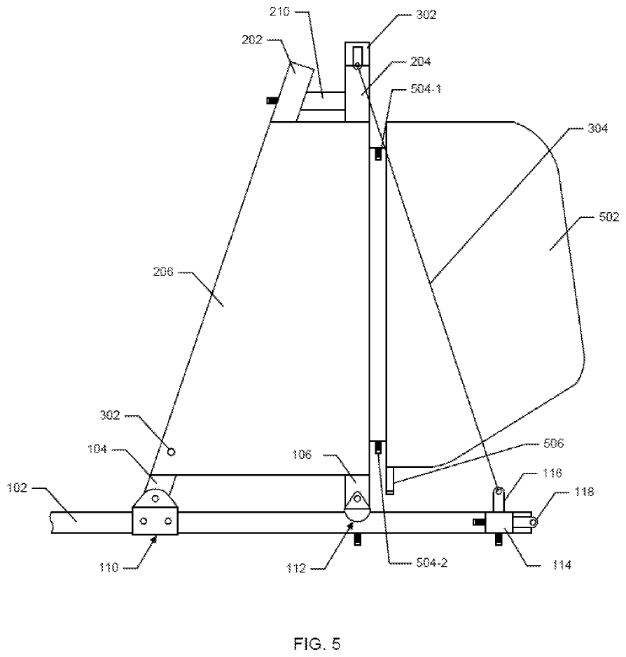

FIG. 5 illustrates an exemplary representation of a rudder coupled with the fin of the collapsible stabilizer assembly in accordance to an embodiment of the present disclosure. In an embodiment, the collapsible stabilizer assembly can include a rudder 502 pivotally attached to trailing edge 204 of the fin 200 with the help of pivot mechanisms 504-1 and 504-2 (collectively referred to as 504) for controlling yaw of the aircraft. The rudder 502 can pivotally move about its pivoted side in order to control directional orientation of the aircraft.

In an embodiment, the rudder 502 can be pre-installed with the fin 200 while the fin 200 is assembled to the frame 102. Hence, the collapsible stabilizer assembly can be assembled or disassembled with ease and without any hassle by implementing the proposed assembly technique as illustrated in FIG. 3.

In an embodiment, a lower portion of the rudder 504 can include a connector link 506 that traverses through lateral direction of the aircraft and is used to connect the rudder 502 with a push-pull mechanism. The connector link 506 can include at least two hooks or circular taps configured on either side of the rudder 502. The hooks connect to the push-pull mechanism to enable pivot movement of rudder 502 about its pivoted side in order to control yaw of the aircraft.

Thus the present discourse provides an aircraft including a collapsible stabilizer assembly to provide directional stability to the aircraft and to reduce aerodynamic side slip experienced by the aircraft. The collapsible stabilizer assembly includes at least one fin having a leading member and a trailing member respectively coupled with a first tube and a second tube that are pivotally fixed to frame of the aircraft. The leading member includes a first hole for engaging a fastening member when the first hole is in alignment with a second hole that is configured in the first tube so as to couple the leading member and the first tube. Coupling of the leading member and the trailing member with the first tube and the second tube respectively allows quick installation as well as removal of the at least one fin from the frame.

It would be appreciated that although the proposed disclosure is explained in terms of application of the proposed technique to tail assembly of an aircraft, the scope of the present disclosure is not limited to the same in any way, and application of the proposed technique to wing assemblies and tube structures of, for example a windmill or a watercraft, is well within the scope of the present disclosure.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### ADVANTAGES OF THE INVENTION

The present disclosure provides a collapsible stabilizer assembly and technique for quick installation and removal of a stabilizer fin of an aircraft.

The present disclosure provides a portable collapsible stabilizer assembly of an aircraft.

The present disclosure provides a collapsible stabilizer assembly that is easily collapsible.

The present disclosure provides a collapsible stabilizer assembly that enables quick assembly of fin of the aircraft.

The present disclosure provides a collapsible stabilizer assembly that can be incorporated as an aircraft wing assembly or tail assembly having any of V-tail, cruciform tail, wingtip, winglet and the like configurations.

The present disclosure provides a collapsible stabilizer assembly that improves portability of the aircraft.

The present disclosure provides a collapsible stabilizer assembly that may be retrofitted to existing microlight as well as flex wing aircrafts without any major design alterations.

The present disclosure provides a collapsible stabilizer assembly that is light in weight and incorporates less number of components.

The present disclosure provides a collapsible stabilizer assembly that retains structural integrity of a wing assembly or a tail assembly of an aircraft.

The present disclosure provides a collapsible stabilizer assembly that provides a built-in fabric tensioning mechanism.

The present disclosure provides a collapsible stabilizer assembly that does not require tools for assembly and disassembly of the stabilizer assembly with frame of the aircraft.

The present disclosure provides a collapsible stabilizer assembly that does not require turnbuckles for adjusting tension between two components.

I claim:

1. A collapsible stabilizer assembly to provide directional stability to an aircraft, the collapsible stabilizer assembly comprising:
at least one fin having a leading member and a trailing member, said leading member and said trailing member respectively coupled with a first tube and a second tube that are pivotally fixed to frame of the aircraft;
wherein said leading member comprises a first hole for engaging a fastening member when said first hole is in alignment with a second hole that is configured in said first tube so as to couple the leading member and the first tube, and wherein coupling of the leading member and the trailing member with the first tube and the second tube respectively allows quick installation of the at least one fin to the frame.

2. The collapsible stabilizer assembly of claim 1, wherein the fastening member is any or a combination of a stud, a bolt, a pin and a quick release pin.

3. The collapsible stabilizer assembly of claim 1, wherein diameter of each of said first tube and second tube is less than diameter of each of said leading member and trailing member such that the first tube and the second tube are capable of being inserted into the leading member and the trailing member respectively.

4. The collapsible stabilizer assembly of claim 1, wherein top end of the leading member is connected to top end of the trailing member.

5. The collapsible stabilizer assembly of claim 1, wherein the frame comprises a link traversing through lateral direction of the aircraft and located at an offset distance from the trailing member, and wherein the link is configured with at least two cables that are connected between ends of the link and top end of the trailing member.

6. The collapsible stabilizer assembly of claim 1, further comprising a rudder pivotally attached to the at least one fin for controlling yaw of the aircraft.

7. The collapsible stabilizer assembly of claim 1, further comprising a fabric wrapped around the leading edge and the tailing edge such that the fabric covers the at least one fin.

8. The collapsible stabilizer assembly of claim 7, wherein tension in the fabric gradually increases with assembly of the at least one fin with the frame.

9. The collapsible stabilizer assembly of claim 7, wherein the at least two cables are connected between ends of the link and top end of the trailing member prior to coupling of the leading member and the trailing member with the first tube and the second tube respectively, to assist tensioning of the fabric.

10. The collapsible stabilizer assembly of claim 7, wherein in case the fabric covering the at least one fin is in pre-tensioned condition, the first tube is removed and the leading member is fastened with a pivotal member the frame using any or a combination of a stud, a bolt, a pin and a quick release pin.

11. The collapsible stabilizer assembly of claim 10, wherein when the fabric covering the at least one fin is in the pre-tensioned condition the at least one fin construe a single frame structure having the leading member and the trailing member emanating outwards at a bottom end of the at least one fin.

12. An aircraft comprising:
a frame comprising at least a first tube and a second tube pivotally fixed to the frame; and
a collapsible stabilizer assembly comprising at least one fin having a leading member and a trailing member operatively coupled with the first tube and the second tube respectively;
wherein said leading member comprises a first hole for engaging a fastening member when said first hole is in alignment with a second hole that is configured in said first tube so as to couple the leading member and the first tube, and wherein coupling of the leading member and the trailing member with the first tube and the second tube respectively allows quick installation of the at least one fin to the frame.

13. The aircraft of claim 12, wherein the fastening member is any or a combination of a stud, a bolt a pin and a quick release pin.

14. The aircraft of claim 12, wherein diameter of each of said first tube and second tube is less than diameter of each of said leading member and trailing member such that the first tube and the second tube are capable of being inserted into the leading member and the trailing member respectively.
